(19) United States
(12) Patent Application Publication
(10) Pub. No.: US 2026/0229925 A1
(43) Pub. Date: Aug. 6, 2026

(54) SELF-OSCILLATING SYSTEM FOR WIRELESS POWER TRANSMISSION AND METHOD OF IMPLEMENTING THE SAME

(71) Applicant: REMOTE ENERGY LTD., Petch Tikva (IL)

(72) Inventor: Alexander AXELROD, Petch Tikva (IL)

(21) Appl. No.: 19/154,200

(22) PCT Filed: Feb. 8, 2024
(86) PCT No.: PCT/IL2024/050154

§ 371 Date: Aug. 6, 2025

Related U.S. Application Data
(60) Provisional application No. 63/444,022, filed on Feb. 8, 2023.
(60) Provisional application No. 63/464,694, filed on May 8, 2023.

(51) Int. Cl. H02J 50/40; H02J 50/05; H02J 50/10; H02J 50/80

(52) U.S. Cl. CPC H02J 50/40; H02J 50/05; H02J 50/10; H02J 50/80

(57) ABSTRACT

A self-oscillating system for wireless power transmission; said system comprises (a) a power amplifier connectable to a power source; (b) at least one wireless coupling arrangement energized by said power amplifier. The coupling arrangement comprises two parallel branches having transmitting TX and receiving RX sections each, and operated in anti-phase. Each TX section further comprises a transmitting coupling device and a transmitting member. Each RX section further comprises a receiving coupling device and a receiving member. The transmitting and receiving members are divided by an air gap. The two parallel branches are connected to a load. The self-oscillating system comprises a feedback mechanism. The wireless power transmitting system further comprises a main computer unit, a sensor for detecting a value of power transmitted to said load, and a voltage-controlled frequency-selective filter for selecting an oscillation frequency corresponding to said maximal power.

### FIELD OF THE INVENTION

The present invention relates to wireless power transmission systems, and more particularly, to capacitive wireless power transmission operating in a self-oscillating mode.

### BACKGROUND OF THE INVENTION

It is known in the art that wireless power transmission (WPT) systems employ near field electromagnetic coupling between transmit (TX) and receive (RX) sites (Power Electronics Handbook (Fourth Edition), Chapter 34 Wireless charging of electric vehicle, 2018, Pages 1113-1137). The coupling between TX and RX sites may be either magnetic, or capacitive. Traditionally, the sine-wave seed power generator on the TX site drives the TX coupling element, which is either RF coil in systems employing inductive coupling (IWPT systems), or metallic plate electrodes in systems employing capacitive coupling (CWPT systems).

In the CWPT systems, TX and RX Coupling Devices (CDs), Impedance Matching Networks (IMNs) and air gaps between TX and RX electrodes constitute a kind of resonant circuit, at which the IMDs compensate for relatively large capacitive reactance of the air gap. The compensation is achieved at the fixed operational frequency defined by seed power generator. Similarly, nowadays IWPT systems employ the resonance effect whereas the entire flow path of radio frequency power constitutes series resonant circuit. In this circuit, reactance contributed by coupling devices located on TX and RX sides of the air gap between TX and RX coils compensate its reactance.

Although IWPT systems have been more popular recently due to their high performance at relatively lower operational frequencies, the CWPT systems are less sensitive to lateral misalignment between TX and RX energy coupling elements. The CWPT systems provide much lower human exposure to hazardous magnetic fields. The high-intensity electric fields (E-fields) in the CWPT systems can be easily shielded from the environment and are characterized by lower manufacturing and deployment costs. The CWPT systems have smaller sizes and the electrodes have lighter weights.

Typically, the WPT systems operate in the industrial or urban environment, which implies close proximity to wet conductive soil, and metallic or dielectric vehicle bodies. In such an environment, the CWPT system application for EV battery charging exhibits the following main parasitic capacitances:
C_{gap}—air gap capacitance between TX and RX electrodes
C_{s,v}—capacitance between the vehicle body and soil
C_{e,e}—capacitance between TX in-phase and anti-phase electrodes
C_{e,v}—capacitance between RX electrode and vehicle
C_{e,s}—capacitance between TX electrode and soil, etc.

The CWPT systems are sensitive to effects generated by parasitic stray capacitances between TX and RX electrodes and co-located metallic and dielectric objects. This technical feature prevents the CWPT technology from wide penetration into consumer markets, and, in particular, to the market of wireless charging of Electric Vehicle (EV) batteries. The power flow diverting effect is extremely intensive in the case of EV battery charging applications.

The frequency tracking mechanism forces the WPT system to operate at a single and fixed frequency which causes generation and irradiation of electromagnetic energy at a single spectral frequency. As a result, intensive electromagnetic fields generated by high-power WPT systems very likely exceed the limits defined in EMC and human radiation hazard regulations.

The enforced operational frequency may not coincide with the resonance frequency of the desired energy path from the output of the power generator on the TX side and the input port of the power rectifier on the RX side. Therefore, the use of adaptive Impedance Matching Networks (IMNs) is needed.

It should be noted that there is a long-felt and unmet need for providing a technically reliable and budget-friendly CWPT system.

### SUMMARY OF THE INVENTION

It is hence one object of the invention to disclose a self-oscillating system for wireless power transmission. The aforesaid system comprises: (a) a power amplifier connectable to a power source; (b) at least one coupling arrangement energized by the power amplifier; the coupling arrangement comprising two parallel branches operating in anti-phase and having transmitting TX and receiving RX sections each; each TX section further comprising a coupling device and a transmitting member (electrode); each RX section further comprising a coupling device and a receiving member (electrode); the transmitting and receiving members (electrodes) being separated by an air gap; the two parallel branches being connected to their rectifiers; the rectified power fed into the energy storage devices (e.g. batteries) loads; each RX section further comprising the signal tapping device, feeding a sample of the received on the RX side signal to the positive feedback mechanism; the said feedback signal feeding the tapped of the RX side signal to the input port of the power amplifier on the TX side; whereas said coupling arrangement forms a closed self-oscillating loop.

The main technical feature of the invention is to provide the self-oscillating system comprising a power amplifier, TX and RX transmitting members (coils in IWPT systems and electrodes in CWPT systems), and energy coupling devices compensating reactive impedance of the air gap between the TX and RX transmitting members, feedback mechanism feeding the transmitted signal tapped on the RX side and fed back to the input port of the power amplifier, further comprising a main computer unit (MCU), at least one first sensor configured for detecting a value of power driven to the load, and a voltage-controlled frequency-selective filter positioned at the input port of the power amplifier and configured for selecting the loop oscillation frequency corresponding to the maximal power and maintaining one-frequency operation mode; the main computer unit is configured for interrogating the value of power fed into the load on the RX side, and generating and transmitting a first control signal to the voltage-controlled frequency-selective filter for searching an operational frequency corresponding to the maximal power fed into the load.

Another object of the invention is to disclose the transmitting and receiving members, which are inductively coupled coils.

A further object of the invention is to disclose the transmitting and receiving members, which are capacitively coupled electrodes.

A further object of the invention is to disclose the at least one field intensity sensor which output signal is fed to the Main Computing Unit (the MCU); the MCU generating control signals to at least one voltage-controlled frequency-selective filter; the communication channel further comprising a feedback transmitter located on the RX side and feedback receiver on the TX side; the feedback signal received on the TX side fed via the frequency selective filter to the input port of the power amplifier.

A further object of the invention is to disclose at least one sensor, either electric or magnetic, which is an RF sampling device configured for detecting field strength at selected spatial location(s).

A further object of the invention is to disclose the main computer unit (MCU) configured for interrogating the sensor output signals and generating and transmitting a control signal to the voltage-controlled delay lines for suppressing fringe electric fields in preselected spatial locations, e.g. within the proximity of the system.

A further object of the invention is to disclose the system comprising at least two coupling arrangements. A first coupling arrangement of the at least two coupling arrangements comprises at least one voltage-controlled frequency-selective filter and/or voltage-controlled delay line controlled by the main computer unit configured for cooperatively maximizing the transmitted power and suppressing fringe electric fields in proximity of said system. The first coupling arrangement of the at least two coupling arrangements functions as a master coupling arrangement and defines oscillations within a second coupling arrangement of the at least two coupling arrangements which functions as a slave coupling arrangement thereof. The oscillations within the first and second coupling arrangements are coherent with each other.

A further object of the invention is to disclose the TX section configured for recognizing the RX section belonging to an authorized customer and permitting power transmission to the load while blocking the power transmission to unauthorized entities.

A further object of the invention is to disclose a positive feedback loop closure mechanism and an authorization mechanism based on modulation of a high-frequency RF carrier by sine waveform being coherent with the power transmission waveform and by a unique digital code assigned to each customer, respectively.

A further object of the invention is to disclose a method of wireless power transmission comprising steps of: a) providing a self-oscillating system for wireless power transmission; the system comprising: (i) a power amplifier connectable to a power source; (ii) at least one coupling arrangement energized by the power amplifier; the coupling arrangement comprising two parallel branches operated in anti-phase and having transmitting TX and receiving RX sections each; each TX section further comprising a coupling device and a transmitting member; each RX section further comprising a coupling device and a receiving member; the transmitting and receiving members being divided by an air gap; each one of the two parallel anti-phase branches being connected to a rectifier feeding the rectified DC current into the load; the feedback network feeding sample of the received signal on the RX side to the input port of the power amplifier; the power amplifier, coupling devices, TX and RX transmitting members, feedback network, forming a closed self-oscillating loop; the self-oscillating system comprises a feedback mechanism further comprising a main computer unit, at least one first sensor configured for detecting a value of current fed into the load on the RX side, and a voltage-controlled frequency-selective filter positioned within the self-oscillating loop, preferably at the input port of the power amplifier and configured for selecting an oscillation frequency corresponding to the maximal power and maintaining single-frequency operation mode; the main computer unit is configured for interrogating the value of transmitted power and generating and transmitting the first control signal to the voltage-controlled frequency-selective filter for searching an operational frequency corresponding to maximal transmitted power and maintain thereat; (b) energizing the power amplifier from the power source; (c) establishing the self-oscillating mode; (d) searching the operational frequencies corresponding to local maximal transmitted to the load power values; (e) selecting a global-maximum frequency corresponding to a global maximum of the transmitted power values; (f) maintaining the global-maximum frequency; (g) periodically recurring steps d and e.

A further object of the invention is to disclose the method comprising steps of proving at least one second sensor configured for detecting strength of either electric or magnetic field in preselected locations in proximity of the system, interrogating the second sensor and generating and transmitting a second control signal to the voltage-controlled delay line for suppressing fringe electric fields in proximity of the system by the main computer unit.

A further object of the invention is to disclose the method comprising steps of providing at least two coupling arrangements; wherein at least one of the two coupling arrangements comprises at least one voltage-controlled frequency-selective filter and/or at least one voltage-controlled delay line controlled by the main computer unit; the method further comprises step of interrogating the at least one first sensor and/or at least one second sensor and generating and transmitting the first and/or second control signals for cooperatively maximizing the transmitted power and suppressing the fringe electric and/or magnetic fields in the proximity of the system.

A further object of the invention is to disclose the step of searching the operational frequencies corresponding to local maximal transmitted power values comprising randomly jittered within a predetermined frequency deviation bandwidth.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of a self-oscillation system for capacitive power transmission;

FIG. 2 is a schematic diagram illustrating the operation mode of a single module for capacitive power transmission;

FIG. 3 is a schematic diagram of a system for capacitive power transmission having multiple TX-RX modules; and

FIG. 4 is a schematic diagram of an oscillator with a positive feedback.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide

The goal of the present invention of making the CWPT systems consistent with human radiation safety requirements. According to the present invention, TX-RX modules of the WPT system are phase-matched and therefore transmit coherent oscillations. Control of relative phases within several TX-RX modules provides cancelation (suppression) of the near-fringe field in dedicated locations of human presence. A number of locations of near-fringe cancellation depends on the number of freedom degrees of in the TX-RX channels comprising of the multiple-modular system.

The present invention implements the near-fringe cancellation in CWPT systems. However, the control of relative phases of the waves carrying the power to be transmitted is also applicable to magnetic and acoustic oscillations.

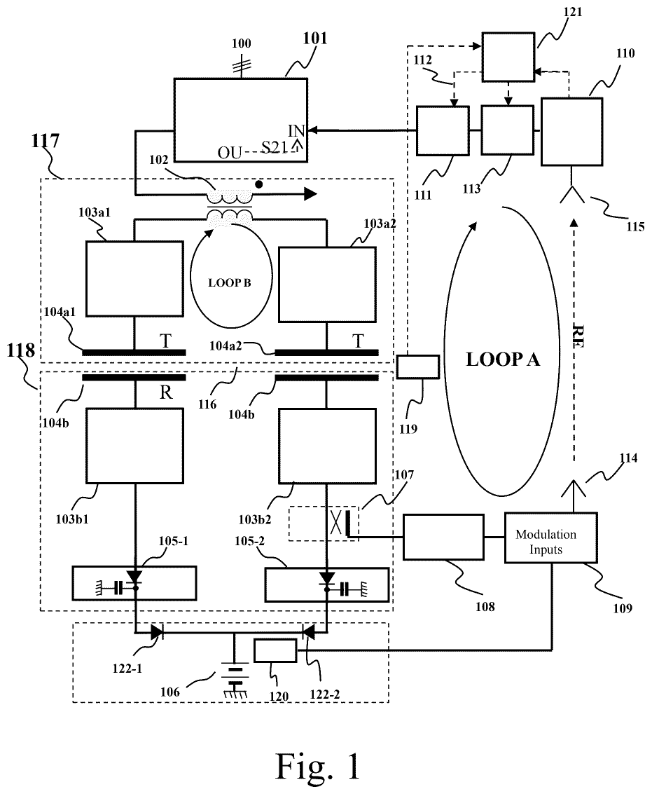

Reference is now made to FIG. 1 presenting a schematic diagram of TX-RX module provided with a closed loop with positive feedback which enables meeting two conditions:
(a) the closed-loop amplification equals unity; and
(b) the loop phase delay equals integer multiples of 360°.

Both conditions are satisfied at operational frequency F₀ and determine it. The desirable closed loop is shown in FIG. 1 as the oval curve A.
a) The following signals can be alternatively used in the feedback mechanisms: a signal sampled from the transmitted power tapped at the receive (RX) side, back to the input port of the Power Amplifier;
b) a tapped signal by the backward feedback signal channel; the backward channel may be provided with a low-power wireless signal transmission such as Bluetooth, WiFi, or any other RF link, employing a carrier at an arbitrary radio frequency much greater than the WPT system operational frequency F₀;
c) an optical link modulated by an electrical signal sampled on the RX side of the module; and
d) an acoustic, preferably ultrasound link modulated by signal sampled on the RX side of the module.

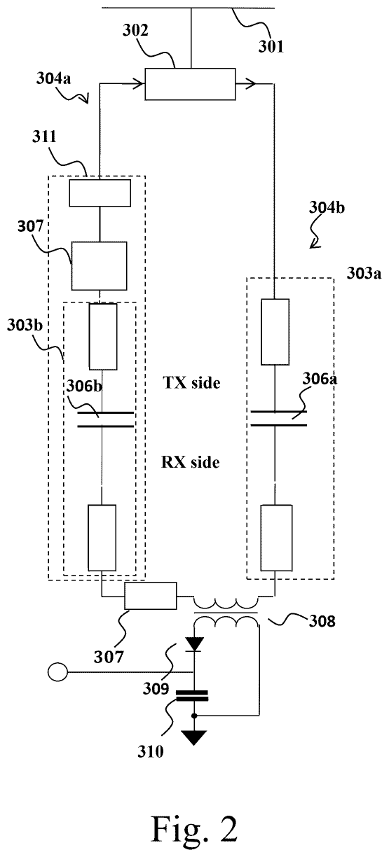

The feedback mechanism (a) is illustrated in FIG. 2 and may employ positive feedback based on the same principle of CWPT. The mechanism (b) is illustrated in FIG. 1, where the feedback employs RF link.

Feedback mechanisms (b), (c) and (d) have smaller number of air electrodes. In all these cases, the feedback loop is independent on the input port of the power amplifier about signals close to operational frequency F₀. Independence of the feedback signal from the power input minimizes the number of parasitic capacitances induced by co-located metallic and dielectric structures and prevents the generation of undesirable oscillating closed loops, circulating the energy in undesirable nonproductive routes. This prevents undesirable losses of TX power to be transmitted. Mechanisms (b) and (c) do not expose the input port of the high-gain power amplifier on the TX site to undesirable energies due to parasitic capacitive couplings.

According to the present invention, the desired closed loop tracing between TX and RX electrodes of the module is discriminated from any other parasitic loops by separating oscillations only at the desired frequency F₀. It suppresses detrimental effects cause by parasitic couplings and prevents the energy to be transmitted from flowing in undesirable directions. In the case of capacitive WPT prone to forming parasitic capacitances between TX and RX electrodes and surrounding massive structures such as vehicle bodies and a roadbed. It should be noted that the parasitic capacitances may exceed the coupling capacitance between TX and RX electrodes by order of magnitude. Therefore, discrimination between desirable energy transmission paths and the aforesaid parasitic paths is enabled voltage-controlled tunable delay lines (113) configured to control and vary phase delay along the desirable closed loop, and by frequency-selective filter (111).

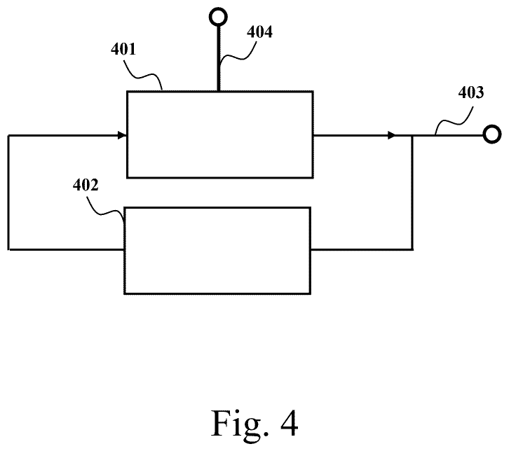

Reference is now made to FIG. 4 illustrating a schematic diagram of the positive feedback oscillator. A small fraction of the power amplifier output power is fed back to the input. For an oscillator, the voltage gain of an amplifier is given by,

$${V}_{f} = \frac{A}{1 - β \cdot A} ,$$

where V_{f} is the voltage gain with feedback, A is the voltage gain without feedback, β is the transfer coefficient of the feedback channel, and the factor β·A is the overall loop gain.

Two Barkhausen conditions should be met in order to generate the desired oscillations.

Condition 1: the overall loop gain should be unity β·A=1. This means that all feedback losses are compensated by the amplifier gain.

Condition 2: the total phase shift around loop gain should be 0° or n×360°, where n is integer number. Physical meaning of the Condition 2 is that energy circulating in the loop performs an integer number of complete transformations from kinetic to potential forms of power.

Once both conditions are satisfied, the linear feedback oscillator will produce sustained oscillations and will generate a coherent sinusoidal signal.

Referring again to FIG. 1, the oscillation conditions are satisfied if the loop gain equals to 1:

$$β ( {F}_{0} ) \cdot A ( {F}_{0} ) = 1 ,$$

and phase delay along the desirable closed loops A and the parasitic closed loop B in FIG. 1 is integer number of 360°. The second condition is satisfied for the loops A and B at different frequencies. Therefore, the power transmission is routed along the desirable oscillation loop.

Meeting the first Barkausen condition is controlled by frequency response of frequency-selective filter (111). The filter may be either low-pass (LPF), bandpass (BPF), or high-pass (HPF) shown at the input port of the TX power amplifier (101). At all undesirable frequencies, corresponding to oscillations at parasitic loops, the filter (111) suppresses amplitude of the input signal and brings the loop gain to values below 1 at all possible oscillation frequencies except the desired frequency F₀.

According to alternative embodiments of the present invention, the system oscillation at the desired energy propagation path between the power amplifier (101) and the RF rectifier (105). For instance, the filter (111) may be designed with fixed or variable bandpass frequency. Similarly, the phase delay element (113) may be designed fixed of variable.

Example 1: the second Barkhausen condition met for loops A and B at different frequencies is controlled by phase delay elements (113) located either in the TX, or in the TX sites, or in both locations.

Example 2: the loop phase delay is fixed, and the pass band of the filter (111) is varied. Then, the first Barkhausen condition is met at frequency defined by the filter (111).

Referring to FIG. 1, RF power amplifier 101 is energized by AC power source 100 e.g. AC power grid. RF power amplifier is characterized by sufficiently large gain and output-input isolation parameter (S21). According to the present invention the system for wireless power transmission comprises TX and RX portions 117 and 118, respectively. The output signal is fed to Balance-to-Unbalance (BALUN) pair of transformers 102. RF BALUN 102 converts the single-ended (SE) RF power at an output port of the power amplifier 101 into a pair of anti-phase RF power signals referred to the common ground potential of the power amplifier 101. BALUN transformer 102 is optionally configured for impedance transformation, as required for optimal impedance matching between the output of the power amplifier 101 and the input port of coupling devices 103al and 103a2. Terminals of the secondary coil are connected to TX coupling devices 103a1 and 103a2 located in two parallel electric circuit branches. converts the single-ended (SE) RF power at the power amplifier output port to a pair of anti-phase RF power signals referred to the common ground potential of the power amplifier The aforesaid TX coupling devices 103al and 103a2 are connected to TX electrodes 104a1 and 104a2 facing RX electrodes 104b1 and 104b2, respectively. Capacitance between TX electrodes 104al and 104a2 and RX electrodes 104b1 and 104b2 is formed by gap 116 between them. The transmitted electric power is then fed to RX coupling device 103b1 and 103b2 and further to RF rectifiers 105-1 and 105-2. The current from both electric branches is fed to battery 106 via diodes 122-1 and 122-2. TX portion 117 is configured for recognizing RX section 118 belonging to an authorized customer and permitting power transmission to the load while blocking the power transmission to unauthorized entities.

The feedback circuit comprises consecutively connected RF sampling device 107, forward power detector 108, feedback transmitter 109, feedback receiver 110, voltage controlled tunable RF delay line (optional) 113, voltage controlled tunable frequency-selective filter 111. Numbers 121 and 112 refer to a main controller unit (MCU) and an analog signal for controlling frequency-selective filter 111. The output signal from frequency-selective filter 111 is fed to amplifier 101.

Referring to examples 1 and 2, MCU 121 controls either phase delay line 113, or the conduction band of the filter 111 in such a way that the battery charging current is maximized. One or both of methods of the system oscillation control may be used to control active power flow exclusively in the desirable routes by suppressing nonproductive power losses within the parasitic loops.

Reference is now made to FIG. 2 presenting a model embodiment of the wireless power transmission system illustrating an operational principle thereof. Specifically, the shown embodiment comprises forward and feedback coupling branches 304a and 304b, respectively. As in the previous embodiment in FIG. 1, the system for wireless power transmission comprises a power source 301 and amplifier 302. Then, the generated oscillations are fed into forward coupling branch 304a and via coupling arrangement 303a having gap 306a to a primary winding of RF impedance transformer 308. Then, the current is directed via delay line 307 to feedback coupling branch 304b via coupling arrangement 303b having air gap 306b. Feedback coupling branch 304b also includes variable delay line 307 and tunable frequency-selective filter 311. Energy-storing capacitor 310 is charged from the secondary winding of RF impedance transformer 308 via rectifying diode 309. Variable delay line 307 enables control of the loop oscillation frequency. Tunable frequency-selective filter 311 separates the oscillation frequency corresponding to the maximal efficiency of power transmission detected by a sensor on the RX side of coupling branches 304a and 304b.

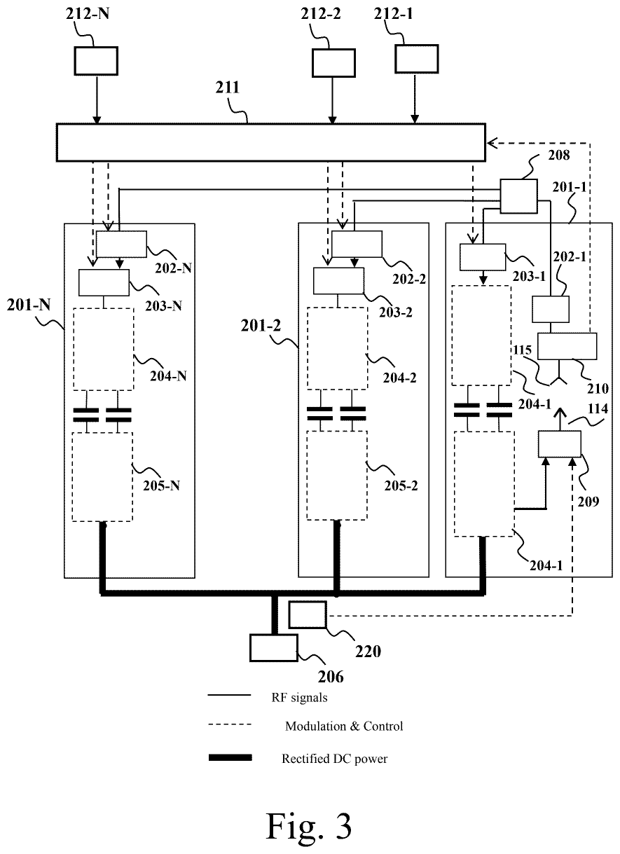

Reference is now made to FIG. 3 presenting an alternative embodiment of the system for wireless power transmission comprising a plurality of identical TX-RX coupling modules. According to the present invention, a plurality of slave modules 201-2 . . . 201-N (minimally one module 201-2), together with master module 201-1 are involved in a single coherent oscillation. The coherency is maintained because phases of modules 201-1 . . . 201-N are synchronized and shifted relatively to the phase of master module 201-1. The described phase-synchronized approach can be useful for an EV charging application when servicing professionals and clients may be in proximity to charging facilities and vehicles to be charged. E-field (or H-field) suppression is implemented by means of adaptive module-to-module (inter-modular) management of relative oscillation phases and amplitudes. Similar to the previously described embodiment, the value of transmitted power is maximized by periodically searching the oscillation frequency corresponding to the maximal transmission.

Specifically, sensor 220 disposed in proximity of load 206 provides a signal corresponding to a current via load 206. This signal via RF transmitter 209, transmitting antenna 114, receiving antenna 115, RF receiver 210, voltage controlled tunable frequency-selective filter 202-1 to power divider 208 providing seed input power to modules 201-1 . . . 201-N. Power divider 208 provides oscillations TX sections 203-2 . . . 203-N of 201-2 . . . 201-N via voltage-controlled delay lines 202-2 . . . 203-N and voltage-controlled tunable frequency-selective filter 203-2 . . . 203-N, respectively. E-field (or H-Field) sensors 212-1, 212-1 . . . 211-N are disposed preferably at the vehicle periphery contour. In general case, some sensors may be wireless and/or wearable, reporting on the E-field value in critical locations. These sensors are a part of the system, and are typically attached to the vehicle bottom surface, the driver or passenger's seats inside the cabin, or be wearable by the protected persons themselves. Sensors 212-1, 212-1 . . . 211-N are in communication MCU 211 interrogating information about the detected local E-field strengths. MCU 211 periodically performs the E-field (or H-field) minimization at all critical locations by changing the relative phase and amplitudes of fields generated modules 201-1 . . . 201-N. Thus, the second-order E-field (or H-field) minimization is achieved by means of adaptive adjustment of relative phases and amplitudes within the balanced TX modules.

The frequency of the self-oscillation is defined primarily by two factors:
(a) the cut-off or center frequency of the Voltage Controlled Filter, F_{FILTER} and by
(b) the S21(f) (see FIG. 1), frequency-dependent transmission function of the RF section comprising TX and RX sections.

The Voltage Controlled Filter typically has B.W. (3 dB) in order of 10-20 kHz which is much less than the bandwidth exhibited by the S21(f) function. Hence, the frequency-selective filter determines the overall transmission function of the entire oscillation loop. F_{FILTER} is controlled by signal developed by the MCU.

The basic operation mode of the WPT system is controlled using the following algorithm:

### Step 1: Data Gathering:

Changing the digital signal, MCU 121/211 gradually sweeps the analog signal within the range corresponding to the entire frequency band [F_{L}−F_{H}], where self-oscillations are feasible. The F_{L} and F_{H} are low and high boundaries, respectively, of the swept frequency band.

The information on the rectified DC power (or DC current) delivered to load 206 is monitored, encoded on the RX side, transmitted by the RF link (109)-(110) to the TX side by the RF Link and stored in a MCU memory register all values of power digital signals corresponding to local maxima of the power delivered to the load on the RX side. The frequencies corresponding to local maxima of the DC power are also stored.

### Step 2: Selecting the Global Maximum Frequency and Operating Thereon

Upon completion of the frequency sweep, MCU 121/211 sets at its output port the voltage, which controls the cut-off or center frequency of the filter 111. The voltage value corresponds to the system oscillation frequency at which the charging DC was the largest. The search operational mode is then followed by the battery charging. The charging period is substantially longer than the searching period.

### Step 3: Periodical Update

The above Steps 1 and 2 are repeated periodically with a duty cycle of an order 1:1000 along the entire Battery charging process.

### Step 4: Charging Termination

The battery charging is terminated upon reaching the Battery charging goal parameters. These parameters are also monitored and their values are also transmitted from the RX to the TX side via the same RF Link. The charging may be terminated when the DC charging current drops to a threshold value.

According to one embodiment of the present invention, the RX side of the system transmits a unique user code via the RF Link (109)-(110). The code is checked on the TX side by MCU 121/211 for matching with the stored codes of the authorized users. This process enables user identification and further billing in the case of multiple-customer operation mode. Optionally, the charging system is configured for recognizing the RX side belonging to an authorized customer and permit power transmission to the load, and block the power transmission to unauthorized entities. A positive feedback loop closure mechanism and an authorization mechanism are based on the modulation of a high-frequency RF carrier by sine waveform being coherent with the power transmission waveform and by a unique digital code assigned to each customer, respectively.

According to another embodiment of the present invention, in the multiple-modules system, additional E-Field (or H-Field) sensors shall be incorporated for monitoring of the fringe field. The gathered data shall be used for optimal active cancellation of the fringe fields at the sensor's locations. The canceling shall be done by phase and amplitude control of the modules of the system.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1.-15. (canceled)

16. A self-oscillating system for wireless power transmission; said self-oscillating system comprising:
a. a power amplifier connectable to a power source;
b. at least one wireless coupling arrangement energized by said power amplifier; said coupling arrangement comprising two parallel branches having transmitting TX and receiving RX sections each, and operated in anti-phase; each TX section further comprising a transmitting coupling device and a transmitting member; each RX section further comprising a receiving coupling device and a receiving member; said transmitting and receiving members being divided by an air gap; said two parallel branches being connected to a load;
wherein said self-oscillating system comprises a feedback mechanism;
said power amplifier, coupling arrangement, and said feedback mechanism forming a closed self-oscillating loop;
said wireless power transmitting self-oscillating system further comprising
a main computer unit,
at least one first sensor configured for detecting a value of power transmitted to said load, and
a voltage-controlled frequency-selective filter positioned at the input port of the power amplifier within said self-oscillating loop, configured for selecting an oscillation frequency and scanning an operational frequency in a single-frequency operation mode;
the feedback signal received on the TX side is fed via the voltage-controlled frequency-selective filter to the input port of the power amplifier; the output signal from the voltage-controlled frequency-selective filter is fed to the amplifier;
said main computer unit is configured for interrogating said value of transmitted power to said load power and generating and transmitting a first control signal to said voltage-controlled frequency-selective filter for selecting said operational frequency corresponding to maximal said transferred transmitted power and maintaining said operational frequency thereat.

17. The system according to claim 16, wherein said transmitting and receiving members are inductively coupled coils.

18. The system according to claim 16, wherein said transmitting and receiving members are capacitively coupled electrodes.

19. The system according to claim 16 comprising a voltage-controlled delay line maintaining said two parallel branches in an antiphase operation mode.

20. The system according to claim 16, wherein said sensor is connected to said voltage-controlled frequency-selective filter positioned at the input port of the power amplifier by a wireless communication channel further comprising an RF feedback transmitted and an RF feedback receiver.

21. The system according to claim 16, wherein said first sensor is an RF sampling device configured for detecting strength of electric field at said RX section.

22. The system according to claim 16 comprising at least one second sensor and configured for detecting strength of electric field in preselected locations in proximity of said system.

23. The system according to claim 19, wherein said main computer unit is configured for interrogating said second sensor and generating and transmitting a second control signal to said voltage-controlled delay line for further suppressing fringe electric fields in proximity of said system.

24. The system according to claim 23 comprising at least two coupling arrangements; wherein a first coupling arrangement of said at least two coupling arrangements comprises at least one voltage-controlled frequency-selective filter positioned at the input port of the power amplifier and/or voltage-controlled delay line controlled by said main computer unit configured for cooperatively maximizing said transmitted power and suppressing fringe electric fields in proximity of said system; said first coupling arrangement of said at least two coupling arrangements functions as a master coupling arrangement and defines oscillations within a second coupling arrangement of said at least two coupling arrangements which functions as a slave coupling arrangement thereof; said oscillations withing said first and second coupling arrangements are coherent with each other.

25. The system according to claim 16, wherein said TX section is configured for recognizing said RX section belonging to an authorized customer and permitting power transmission to said load while blocking said power transmission to unauthorized entities.

26. The system according to claim 25, wherein a positive feedback loop closure mechanism and an authorization mechanism are based on modulation of a high-frequency RF carrier by sine waveform being coherent with the power transmission waveform and by a unique digital code assigned to each customer, respectively.

27. A method of wireless power transmission comprising steps of:
a. providing a self-oscillating system for wireless power transmission; said system comprising:
i. a power amplifier connectable to a power source;
ii. at least one coupling arrangement energized by said power amplifier; said coupling arrangement comprising two parallel branches operating in anti-phase and having transmitting TX and receiving RX sections each; each TX section further comprising a transmitting device and a transmitting member; each RX section further comprising a receiving device and a receiving member; said transmitting and receiving members being divided by an air gap; said two parallel branches being connected to a load;
said self-oscillating system comprises a feedback mechanism;
said power amplifier, coupling arrangement, and said feedback mechanism forming a closed self-oscillating loop;
said self-oscillating system further comprising a main computer unit, at least one first sensor configured for detecting a value of power transmitted to said load, and a voltage-controlled frequency-selective filter positioned at the input port of the power amplifier within said self-oscillating loop, configured for selecting an oscillation frequency and scanning an operational frequency in a one-frequency operation mode; the feedback signal received on the TX side is fed via the frequency-selective filter to the input port of the power amplifier; the output signal from the frequency-selective filter is fed to the amplifier;
said main computer unit is configured for interrogating said value of transmitted power and generating and transmitting a first control signal to said voltage-controlled frequency-selective filter for searching and selecting said operational frequency corresponding to said maximal transferred power and maintaining said operation frequency thereat;
b. energizing said power amplifier from said power source;
c. establishing said self-oscillating mode;
d. searching scanning said operational frequencies corresponding to local maximal transferred power values;
e. selecting a global-maximum frequency corresponding to a global maximum of said transmitted power values;
f. maintaining said global-maximum frequency;
g. periodically recurring steps d and e.

28. The method according to claim 27 comprising steps of proving at least one second sensor configured for detecting strength of electric field in proximity of said system, interrogating said second sensor and generating and transmitting a second control signal to said voltage-controlled delay line for suppressing fringe electric fields in proximity of said system by said main computer unit.

29. The method according to claim 26 comprising steps of providing at least two coupling arrangements; wherein at least one of said two coupling arrangements comprises at least one voltage-controlled frequency-selective filter positioned at the input port of the power amplifier and/or at least one voltage-controlled delay line controlled by said main computer unit; said method further comprises step of interrogating said at least one first sensor and/or at least one second sensor and generating and transmitting said first and/or second control signals for cooperatively maximizing said transmitted power and suppressing said fringe electric fields in said proximity of said system.

30. The method according to claim 27, wherein said step of searching said operational frequencies corresponding to local maximal transferred power values comprises randomly jittered within a predetermined frequency deviation bandwidth
